(19) United States
(12) Patent Application Publication
(10) Pub. No.: US 2015/0082402 A1
(43) Pub. Date: Mar. 19, 2015

(54) SYSTEM AND METHOD FOR AUTOMATED AUTHENTICATION

(71) Applicant: Talk.To FZC, Ras Al Khaimah (AE)

(72) Inventor: Bhavin Turakhia, Mumbai (IN)

(73) Assignee: Talk.to FZC, Ras Al Khaimah (AE)

(21) Appl. No.: 14/295,136

(22) Filed: Jun. 3, 2014

(30) Foreign Application Priority Data
Sep. 18, 2013 (IN) 3013/MUM/2013

(51) Int. Cl. H04L 29/06

(52) U.S. Cl. CPC H04L 63/0876
USPC 726/7

(57) ABSTRACT

In example embodiments, a system and method for automated authentication are provided. A service provider system receives a message triggered by an application operating on a user device of a user. A contact identifier corresponding to the user device is determined from the message. A reply message that includes a token is transmitted to the contact identifier. A return token is received from the application that intercepted the reply message and extracted the token without user intervention. The return token is compared to the token sent in the reply message. Based on the return token matching the sent token, the contact identifier is verified as corresponding to the user device.

### CROSS-REFERENCE TO RELATED APPLICATIONS

The present application claims the benefit of priority under 35 U.S.C. §119 to Indian Application No. 3013/MUM/2013, filed on Sep. 18, 2013, which is incorporated herein by reference in its entirety.

### FIELD

The present disclosure relates generally to network communication, and in a specific example embodiment, to automated authentication with a system.

### BACKGROUND

Typically, when a user downloads an application to their device, the user has to perform a series of handshakes in order to be authenticated with a system that provides service for the application. For example, the user may manually open the application and be asked to provide a mobile number for their device. The system may then send a message to the device and request the user manual identify and return a verification code or token to the system. If this verification code is validated, the user is authenticated with the system.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for managing contacts in a network may be implemented.

FIG. 2 is a block diagram illustrating an example embodiment of a client device.

FIG. 3 is a block diagram illustrating an example embodiment of a service provider system.

FIG. 4 is a flow diagram of an example method for automated authentication.

FIG. 5 is a communication flow diagram of an example method for automated authentication.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for automated authentication and verification of a contact identifier corresponding to a user device. A service provider system receives a message triggered by an application operating on the user device of a user. The contact identifier corresponding to the user device is determined from the message. For example, the contact identifier may be extracted from a header or body of the received message. A reply message that includes a token is transmitted to the contact identifier. A return token is received from the application that intercepted the reply message and extracted the token. The return token is compared to the token sent in the reply message. Based on the return token matching the sent token, the contact identifier is verified as corresponding to the user device.

By using example embodiments, a user of a device does not need to manually perform any operations in order to be authenticated with a service provider system. Accordingly, one or more of the methodologies discussed herein may obviate a need fir manual user input in order to be authenticated (e.g., sign in or create an account) with the service provider system. By automating the process, example embodiments alleviate problems associated with human error in providing requested information for authentication purposes. This may have the technical effect of reducing computing resources used by one or more devices within the system. Examples of such computing resources include, without limitation, processor cycles, network traffic, memory usage, storage space, and power consumption.

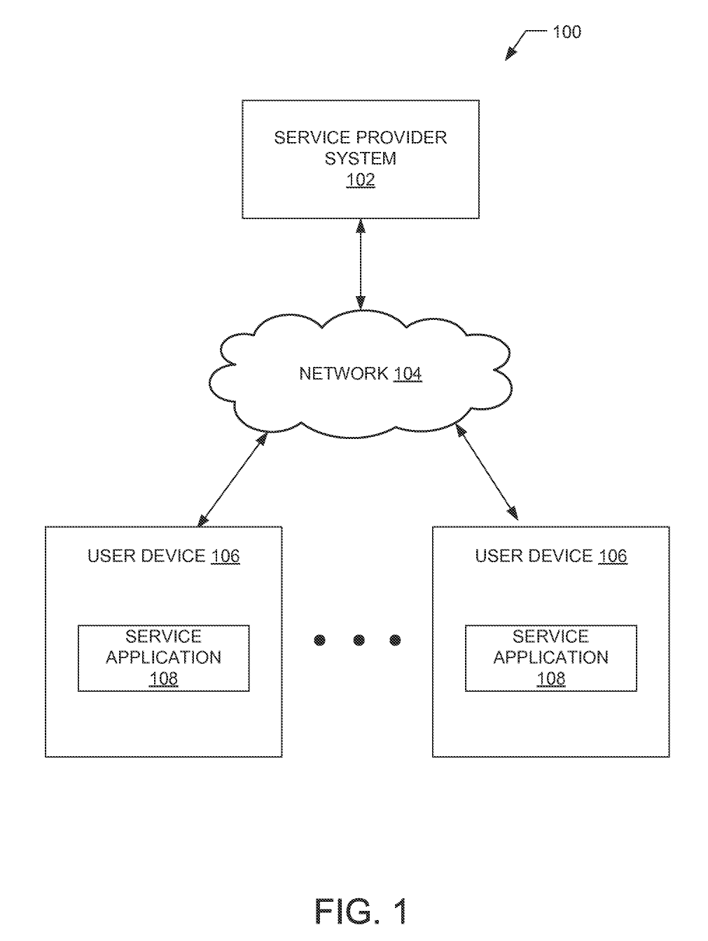

With reference to FIG. 1, a diagram illustrating an example environment 100 in which embodiments of a system fir automated authentication is shown. The environment 100 comprises a service provider system 102 coupled via a network 104 (e.g., the Internet, wireless network, cellular network, or a Wide Area Network (WAN)) to a plurality of user devices 106. Each user device 106 is associated with a user that has downloaded or otherwise installed a service application 108 onto their respective user device 106. The user device 106 may comprise a mobile phone, laptop, tablet, or any other communication device that a user may utilize to store, access, or operate the service application 108.

The service application 108 comprises a piece of functionality on the user device 106 that provides access to functions or operations corresponding to the service provider system 102. To that end, the service provider system 102 may provide the service application 108 to the user device 106 (e.g., provide a downloadable version of the service application, electronically send the service application to the user device 106, physically send to the user via a storage medium such as a CD ROM).

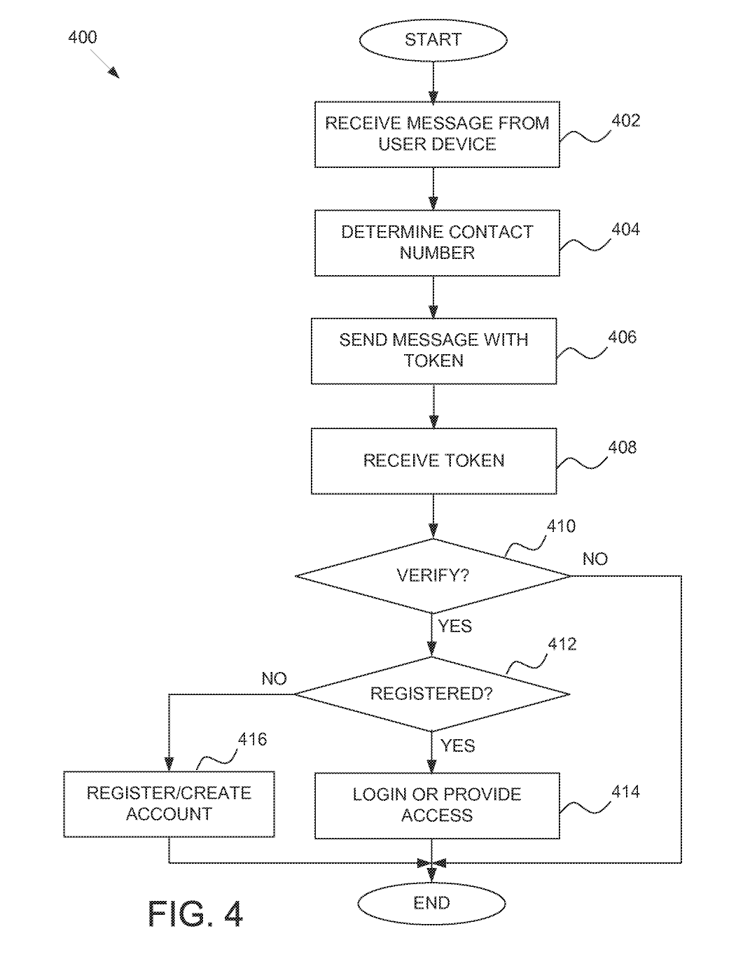

Once the service application 108 is installed on the user device 106, the service application 108 may automatically verify a contact identifier corresponding to the user device 106 (e.g., mobile number, e-mail address, phone number) and authenticate the user device 106 and/or the user with the service provider system 102. The authentication process may occur in the background of the user device 106 without any user intervention. The user may not even be aware that the authentication process is occurring. The authentication process will be discussed in more detail in connection with FIG. 4 below.

It is noted that the environment 100 shown in FIG. 1 is exemplary. Alternative embodiments may comprise any number of service provider systems 102 and user devices 106 in communication in the environment 100.

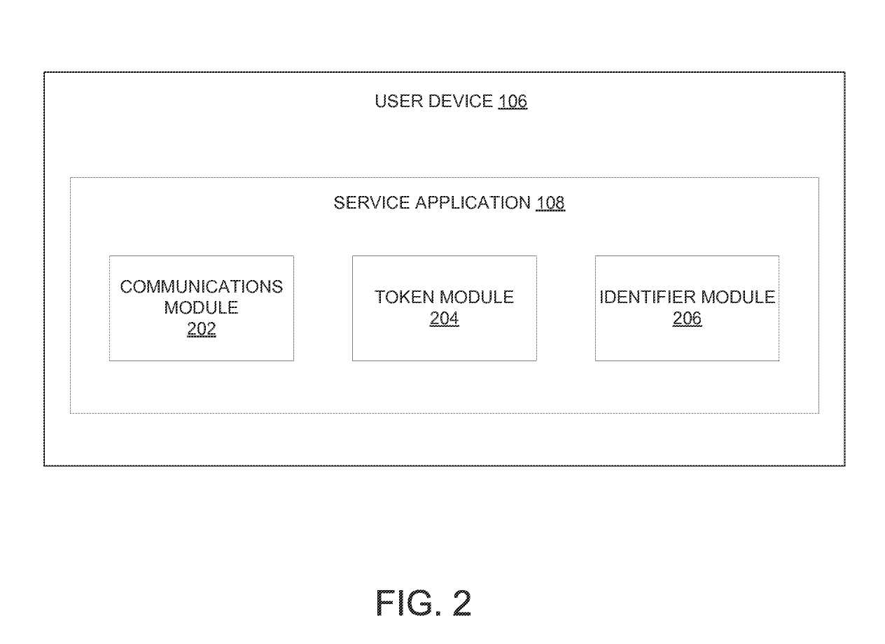

Referring now to FIG. 2, a block diagram illustrating an example embodiment of the user device 106 is shown. The user device 106 is shown having the service application 108 installed thereon. The service application 108 provides functionality and services to the user device 106 that may be provided from the service provider system 102. To enable the functionality on the user device 106, the service application 108 may comprise a communications module 202, a token module 204, and an identifier module 206. It is noted that the service application 108 may comprise other modules not pertinent to example embodiments that are not shown or discussed.

The communications module 202 manages communications with the service provider system 102. Upon installation, the communications module 202 may exchange communications with the service provider system 102 to perform the verification and authentication. In example embodiments, the communications module 202 may take over control of SMS messaging capabilities of the user device 106 to exchange the communications. Accordingly, the communications module 202 determines a service number (e.g., phone number) for the service provider system 102 and uses that service number to send a SMS message to the service provider system 102. In one embodiment, the service number may be fetched by the communication module 202 from the service provider system 102. Alternatively, the service number may be hardcoded into the service application 108. The communications module 202 also receives SMS replies from the service provider system 102.

One of the SMS replies may include a token or other verification code from the service provider system 102. The token module 204 extracts the token from the SMS reply. The token may then be returned to the service provider system 102 to verify the contact identifier corresponding to the user device 106 by the communications module 202.

A further message from the service provider system 102 may provide a contact identifier (e.g., mobile number) to the user device 106 to the service application 108. In example embodiments, the service application and/or the user device 106 may not have knowledge of the contact identifier corresponding to the user device 106. The identifier module 206 may extract this contact identifier and store the contact identifier for later use by the service application 108 or the user device 106.

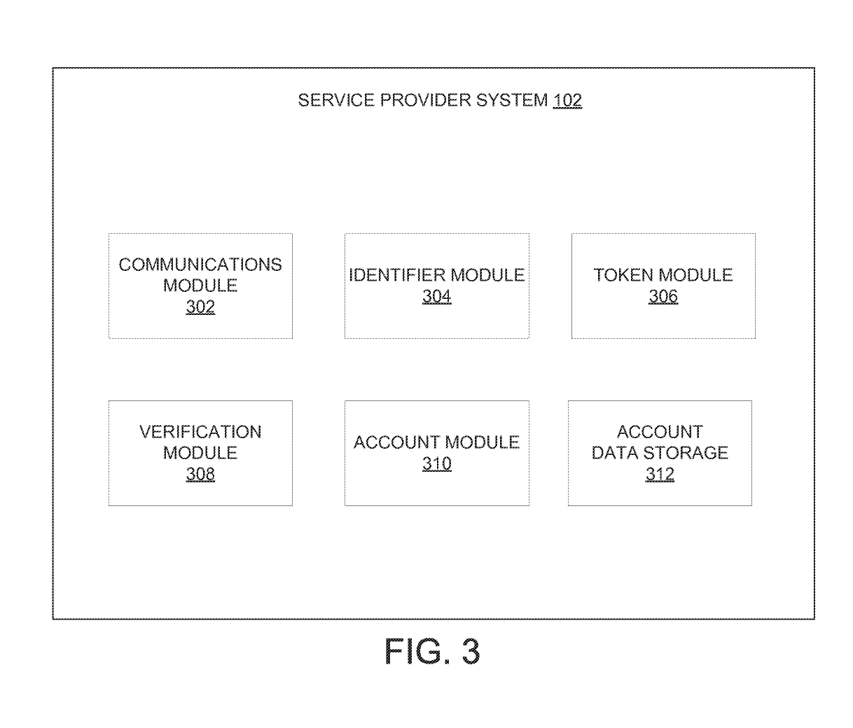

Referring now to FIG. 3, the service provider system 102 is shown in more detail. In example embodiments, the service provider system 102 comprises one or more servers that provide functionality and services to the service applications 108 running on the user devices 106. Prior to allowing the service application 108 to access content or functionalities with the service provider system 102, the contact identifier corresponding to the user device 106 is verified as belonging to the user device 106 and/or the user device 106 is authenticated. In example embodiments, the service provider system 102 uses the contact identifier (e.g., mobile number) corresponding to the user device 106 as an authentication vector. Accordingly, the service provider system 102 may comprise a communications module 302, an identifier module 304, a token module 306, a verification module 308, an account module 310, and an account data storage 312. Alternative embodiments may comprise more, less, or other modules for managing contacts in the network. Some functions of the modules may be combined or divided into two or more further modules.

The communications module 302 manages communications with the user devices 106. Accordingly, the communications module 302 may receive SMS messages and web requests from the user device 106. The communications module 302 may also provide reply messages to the user device 106.

The identifier module 304 determines a co tact identifier corresponding to the user device 106. In example embodiments, when a first SMS message is received from the service application 108 of the user device 106, the identifier module 304 may extract the contact identifier from a header or body of the SMS message. The contact identifier corresponding to the user device 106 may be stored in the service provider system 102 (e.g., in the account data storage 312) and used to provide reply messages to the user device 106.

The token module 306 selects a token to provide to the user device 106 for the authentication process. For example, the token module 306 may generate the token, store the token in association with the contact identifier, and provide the token to the communications module 302 to be returned to the user device 106 in a reply SMS message.

The verification module 308 verifies a returned token from the application of the user device 106. For example, the service application 108 at the user device 106 may intercept the reply SMS message and extract the token in the SMS reply all without user intervention. The token may then be returned to the service provider system 102 by the service application 108 to authenticate the contact identifier corresponding to the user device 106. In one embodiment, the token is returned via a web request. In alternative embodiments, other forms of communications may be used to return the token (e.g., SMS messaging). The verification module 308 compares the returned token to a record of the token that was sent to the contact identifier. Based on the returned token matching the stored token, the verification module 308 verifies the contact identifier belongs to or is associated with the user device 106 returning the token.

Once authenticated, the account module 310 may determine whether the contact identifier is registered with the service provider system 102. Accordingly, the account module 310 may perform a lookup in the account data storage 312. If the contact identifier is already registered then an account may already exist for the user/user device 106 and the user or user device 106 may be automatically logged into their account without any user intervention. Thus, the contact identifier is verified and the user is logged in or otherwise allowed to access services of the service provider system 102 without the user having to perform any actions after the installation of the service application 108. However, if the contact identifier is not registered, then an account may be created for the user or user device 106 and the contact identifier is registered by the account module 310. The account creation and contact identifier registration may also occur without any user intervention.

FIG. 4 is a flow diagram of an example method 400 for automated verification of a contact identifier and authentication of the user device 106. The operations of the method 400 may be performed by the service provider system 102 which may be embodied on one or more servers. In operation 402, the communications module 302 receives a message from the user device 106. In example embodiments, the message is a SMS message.

In operation 404, the identifier module 304 determines the contact identifier corresponding to the user device 106 that sent the message. In one example, the user device 106 may be a mobile device (e.g., a smartphone) and the contact identifier is a mobile number of the mobile device The identifier module 304 may determine the contact identifier by extracting the number, for example, from a header or body of the SMS message. The contact identifier may then be stored (e.g., in the account data storage 312) for later access and verification.

In operation 406, the communications module 302 sends a reply message to the contact identifier that was determined in operation 404 with a token (or other form of a verification code). The token may be selected by the token module 306 and provided to the communications module 302 for inclusion in the reply message. In example embodiments, the reply message comprises a reply SMS message.

In operation 408, a return token is received in a communication from the user device 106 by the communications module 302. The returned token is a token extracted by the service application 108 from the SMS reply and returned to authenticate the user device 106. In example embodiments, the service application 108 intercepts the reply message and extracts the token without user intervention. The user may not even be aware of the SMS messaging since the communications are occurring in the background. The token is provided to the verification module 308.

In operation 410, the verification module 308 determines if the returned token matches the token that was sent to the contact identifier corresponding to the user device 106. Accordingly, the verification module 308 compares the returned token to the token that was recorded in association with the contact identifier corresponding to the user device 106, If the returned token is not verified (e.g., does not match the recorded token), then the method 400 may end. In this case, the service application 108 may be notified of the authentication failure and other forms of authentication may need to be performed (e.g., a conventional manual process by the user).

If the returned token is verified (e.g., matches the recorded token), then a determination is made in operation 412 as to whether the contact identifier is already registered with the service provider system 102. The account module 310 may make the determination according to example embodiments. If the contact identifier is already registered and an account exists, then the user/user device 106 may be automatically logged into their account or otherwise allowed to access content and functionality at the service provider system 102 in operation 414. However, if the contact identifier is not registered in operation 412, then the contact identifier may be registered and an account created in operation 416.

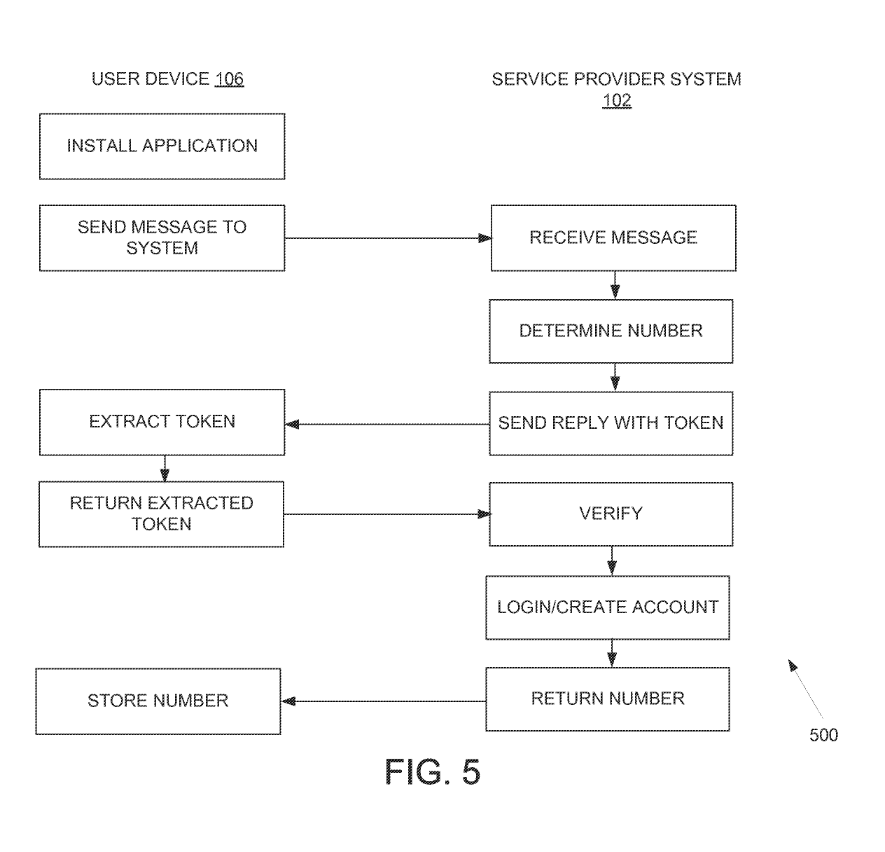

FIG. 5 is a communication flow diagram of an example method 500 for automated verification of a contact identifier and authentication of the corresponding user device 106. Initially, the service application 108 is installed onto the user device 106. Upon installation, the service application 108 automatically initiates the authentication process, which may be performed in the background without any user intervention or awareness. In one embodiment, the service application 108 may fetch a service number for the service provider system 102 prior to sending a first message to the service provider system 102, For example, the service application 108 may send a web request to the service provider system 102 for the service number. In an alternative embodiment, the service number may be hardcoded in the service application 108.

Using the service number, the user device 106 sends a message to the service provider system 102. In example embodiments, the message may be a SMS message. However, it is noted that other forms of communication may be used (e.g., a phone call, e-mail). The service provider system 102 receives the message and determines a contact identifier corresponding to the user device 106 that the service application 108 was installed on and from which the message was received. In example embodiments, the contact identifier may be extracted from a header or body of the received message. The contact identifier may be stored for later use by the service provider system 1102.

Using the contact identifier, the service provider system 102 sends a reply with a token to the user device 106. The token may be a unique verification code that was selected for the particular user device 106 corresponding to the contact identifier. Accordingly, a record of the token sent to the user device 106 is stored with the contact identifier at the service provider system 102.

At the user device 106, the service application 108 intercepts the reply message (e.g., it may not be displayed to the user nor is the user aware that an SMS session is occurring on their user device 106). The service application 108 then extracts the token from the reply message. The extracted token is returned to the service provider system 102 to verify the contact identifier and to authenticate the user/user device 106. In one embodiment, the extracted token is returned using a web service request. In alternative embodiments, other forms of communications may be used to return the extracted token (e.g., SMS message).

The service provider system 102 receives the returned token and performs a verification process. in example embodiments, the service provider system 102 compares the returned token to the recorded token associated with the contact identifier corresponding to the user device 106 that returned the token. If the returned token matches the recorded token, then contact identifier is verified and the user/user device 106 is authenticated with the service provider system 102. Accordingly, the user may be automatically logged into their account or an account may be generated, if one does not exist.

In some embodiments, the service provider system 102 returns the contact identifier (e.g., mobile number) to the service application 108 at the user device 106. That is, the service application 108 may have no knowledge of what the contact identifier of the user device 106 is until the service provider system 102 provides the contact identifier. The service application 108 may then store the contact identifier for later use.

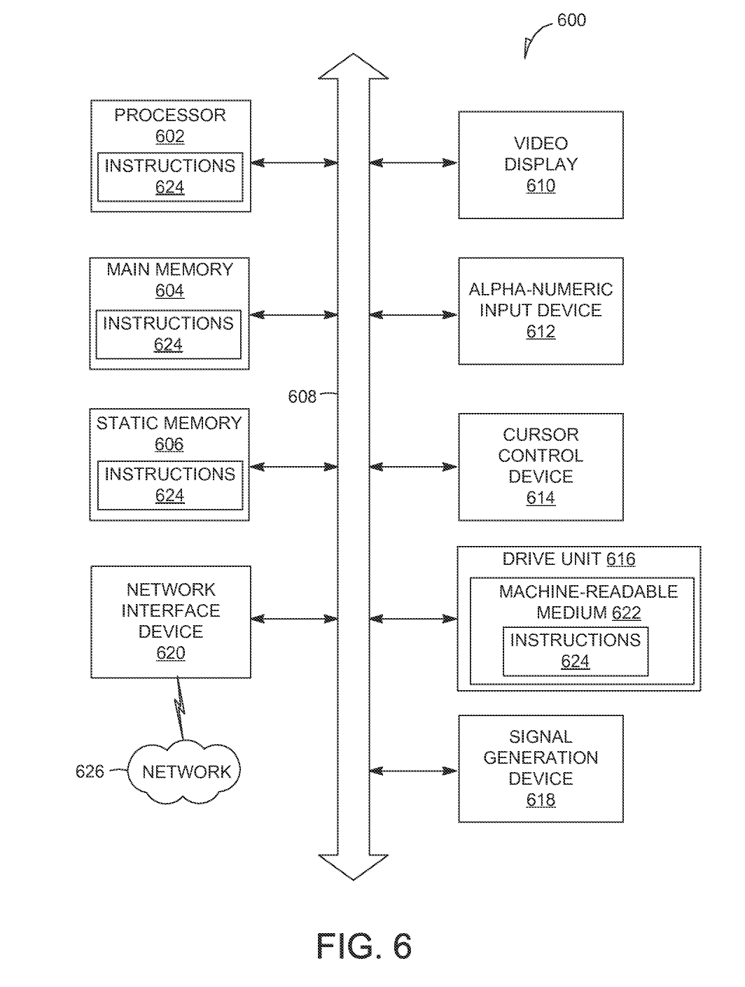

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software, a program, an application, un applet, an app, or other executable code) for causing the machine 600 to perform any one or more of the methodologies discussed herein may be executed. In alternative embodiments, the machine 600 operates as a standalone device or may be connected (e.g., networked) to other machines. in a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alpha-numeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the tangible machine-readable medium 622 is shown in an example embodiment to be a single medium, the term “machine-readable medium” should be taken to include a single medium or multiple media e.g., a centralized or distributed database, or associated caches and servers) able to store instructions. The term. “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement the medium should be considered as being transportable from one physical location to another. Additionally, since the machine-readable medium is tangible, the medium may be considered to be a machine-readable device.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application poi o as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refer to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware, For example, at least sonic of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors^{.}), with these operations being accessible via a network (e.g., the Internet) and via one or more appropriate interfaces (e.g., application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader scope of embodiments of the present invention. Such embodiments of the inventive subject matter may be referred to herein, individually, or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims, The specification and drawings are, accordingly, to be regarded in an illustrative rather than a restrictive sense.

What is claimed is:

1. A method comprising:
receiving, at a service provider system, a message triggered by an application operating on a user device of a user;
identifying a contact identifier corresponding to the user device from the message;
transmitting a reply message that includes a token to the contact identifier;
receiving a return token from the application that intercepted the reply message and extracted the token from the reply message without user intervention; and
verifying, using a hardware processor, that the return token matches the token sent in the reply message, the verifying confirming that the contact identifier corresponds to the user device.

2. The method of claim 1, wherein the receiving the message is via a SMS message.

3. The method of claim 1, wherein the receiving the return token from the application of the user device is via one of an SMS message, a web request, or an email from the user device

4. The method of claim 1, further comprising, based on the verifying that the return token matches the token sent in the reply message:
determining whether an account exists for the user corresponding to the contact identifier; and
based on an account not existing, automatically creating an account for he user corresponding to the contact identifier.

5. The method of claim 1, further comprising, based on the verifying that the return token matches the token sent in the reply message, automatically logging in the user with the service provider system.

6. The method of claim 1, further comprising, based on the verifying that the return token matches the token sent in the reply message, providing access to functionality provided by the service provider system to the user device.

7. The method of claim 1, further comprising, based on the verifying that the return token matches the token sent in the reply message, providing the contact identifier to the user device.

8. The method of claim 1, wherein the identifying the contact identifier comprises extracting the contact identifier from at least one of a header or a body of the message.

9. The method of claim 1, where the receiving of the message further comprises receiving the message at a service number provided to the application in response to a request prior to the receiving of the message.

10. A tangible machine-readable medium in communication with at least one processor, the tangible machine-readable medium storing instructions which, when executed by the at least one processor of a machine, cause the machine to perform operations comprising:
receiving, at a service provider system, a message triggered by an application operating on a user device of a user;
identifying a contact identifier corresponding to the user device from the message;
transmitting a reply message that includes a token to the contact identifier;
receiving a return token from the application that intercepted the reply message and extracted the token from the reply message without user intervention; and
verifying that the return token matches the token sent in the reply message, the verifying confirming that the contact identifier corresponds to the user device.

11. The tangible machine-readable medium of claim 10, further comprising, based on the verifying that the return token matches the token sent in the reply message:
determining whether an account exists for the user corresponding to the contact identifier; and
based on an account not existing, automatically creating an account for the user corresponding to the contact identifier.

12. The tangible machine-readable medium of claim 10, wherein the operations further comprise, based on the verifying that the return token matches the token sent in the reply message, automatically logging in the user for the service.

13. The tangible machine-readable medium of claim 10, wherein the operations further comprise, based on the verifying that the return token matches the token sent in the reply message, providing access to functionality provided by the service provider system to the user device.

14. The tangible machine-readable medium of claim 10, wherein the operations further comprise, based on the verifying that the return token matches the token sent in the reply message, providing the contact identifier to the user device.

15. The tangible machine-readable medium of claim 10, wherein the identifying the contact identifier comprises extracting the contact identifier from at least one of a header or a body of the message.

16. A system comprising:
a processor of a machine;
a communications module to receive, at a service provider system, a message triggered by an application operating on a user device of a user;
an identifier module to identify a contact identifier corresponding to the user device from the message, the communications module to transmits a reply message that includes a token to the contact identifier and to receive a return token from the application that intercepted the reply message and extracted the token from the reply message without user intervention; and
a verification module to verify that the return token matches the token sent in the reply message, the verifying confirming that the contact identifier corresponds to the user device.

17. The system of claim 16, further comprising an account module to, based on the return token matching the token sent in the reply message:
determine whether an account exists for the user corresponding to the contact identifier, and
based on an account not existing, automatically create an account for the user corresponding to the contact identifier.

18. The system of claim 16, further comprising an account module to, based on the return token matching the token sent in the reply message, automatically log in the user for the service.

19. The system of claim 16, wherein the communication module is further to, based on the return token matching the token sent in the reply message, provide the contact identifier to the user device.

20. The system of claim 16, wherein the identifier module identifies the contact identifier by extracting the contact identifier from at least one of a header or a body of the message.
